(19) United States
(12) Patent Application Publication
(10) Pub. No.: US 2024/0201725 A1
(43) Pub. Date: Jun. 20, 2024

(54) PEDAL DEVICE

(71) Applicant: DENSO CORPORATION, Kariya-city (JP)

(72) Inventors: Masashi ARAO, Kariya-city (JP); Etsugo YANAGIDA, Kariya-city (JP); Daisuke HOKUTO, Kariya-city (JP); Atsushi NISHIMURA, Kariya-city (JP); Kengo ITO, Kariya-city (JP); Genki SUZUKI, Kariya-city (JP); Hiroto YOSHIDA, Toyota-shi (JP)

(21) Appl. No.: 18/586,887

(22) Filed: Feb. 26, 2024

Related U.S. Application Data
(63) Continuation of application No. PCT/JP2022/032114, filed on Aug. 25, 2022.

(30) Foreign Application Priority Data
Sep. 1, 2021 (JP) 2021-142748
Mar. 24, 2022 (WO) PCT/JP2022/013796

(51) Int. Cl. G05G 1/44; G05G 1/46

(52) U.S. Cl. CPC G05G 1/44; G05G 1/46

(57) ABSTRACT

A pedal pad includes a plate part having a plate shape. When a driver performs a depression operation on a plate part from one side in a plate thickness direction, the pedal pad rotates about an axis perpendicular to an extending direction of the plate part. A shaft member is provided at a position away and downward in a vehicle from the plate part. A housing rotatably supports the shaft member. A connecting portion connects the pedal pad and the shaft member. Such a pedal device is an organ-type pedal device in which a pedal lower end is positioned below in the vehicle than a pedal upper end when the plate part is not subject to the depression operation by the driver in the non-depressed state. The pedal device is provided with a gap between the housing and the pedal lower end.

### CROSS REFERENCE TO RELATED APPLICATION

The present application is a continuation application of International Patent Application No. PCT/JP2022/032114 filed on Aug. 25, 2022, which designated the U.S. and claims the benefit of priority from Japanese Patent Application No. 2021-142748 filed on Sep. 1, 2021, and International Patent Application No. PCT/JP2022/013796 filed on Mar. 24, 2022. The entire disclosures of all of the above applications are incorporated herein by reference.

### TECHNICAL FIELD

The present disclosure relates to a pedal device to be mounted on a vehicle.

### BACKGROUND

Conventionally, an organ-type pedal device is known in which a portion of a pedal pad that is depressed by a driver is arranged above an axis of swinging in a vertical direction when mounted on a vehicle. The organ-type pedal device is used as an accelerator pedal device, a brake pedal device, or the like.

### SUMMARY

According to an aspect of the present disclosure, a pedal device includes a pedal pad, a shaft member, a housing, and a connecting portion. The pedal pad has a plate-shaped plate part that has a thickness in a thickness direction and extends in an extending direction. When the driver depresses the plate part from one side in the thickness direction, the pedal pad rotates about an axis that is perpendicular to the extending direction. The shaft member is provided to extend in the axial direction of the axis at a position farther downward in a vehicle than the plate part. The housing rotatably supports the shaft member. The connecting portion connects the pedal pad and the shaft member. The pedal device is an organ-type pedal device in which a pedal upper end on one side in the extending direction of the pedal pad is positioned at an upper position of the vehicle than a pedal lower end on an another side in the extending direction of the pedal pad, in a non-depressed state in which the depression operation by the driver is not performed on the plate part. In the pedal device, a gap is provided between the housing and the pedal lower end.

### BRIEF DESCRIPTION OF THE DRAWINGS

Objects, features, and advantages of the present disclosure will become more apparent from the following detailed description made with reference to the accompanying drawings, in which:

FIG. 1 is a perspective view of a pedal device according to a first embodiment;

FIG. 2 is a view when being viewed from a direction II in FIG. 1;

FIG. 3 is a cross-sectional view taken along a line III-III of FIG. 2;

FIG. 4 is a cross-sectional view taken along a line IV-IV in FIG. 3;

FIG. 5 is a side view of a pedal device according to a second embodiment;

FIG. 6 is a cross-sectional view taken along a line VI-VI in FIG. 5;

FIG. 7 is an explanatory diagram for explaining how foreign matter is removed from the pedal device according to the second embodiment;

FIG. 8 is a cross-sectional view of a portion corresponding to FIG. 6 in a pedal device according to a third embodiment;

FIG. 9 is a cross-sectional view of a portion corresponding to FIG. 6 in a pedal device according to a fourth embodiment;

FIG. 10 is a cross-sectional view of a portion corresponding to FIG. 6 in a pedal device according to a fifth embodiment;

FIG. 11 is a side view of a pedal device of a reference example;

FIG. 12 is a side view of a pedal device according to a sixth embodiment;

FIG. 13 is an explanatory diagram of explaining a depression operation of a pedal in the pedal device according to the sixth embodiment;

FIG. 14 is a side view of a pedal device according to a seventh embodiment;

FIG. 15 is an explanatory diagram for explaining a depression operation of a pedal in the pedal device according to the seventh embodiment;

FIG. 16 is an enlarged view of a part XVI of FIG. 15;

FIG. 17 is a perspective view of a pedal device according to an eighth embodiment;

FIG. 18 is a side view of the pedal device according to the eighth embodiment;

FIG. 19 is a side view of the pedal device according to the eighth embodiment, in which members hidden by a housing, a pedal pad, a protection plate, and the like are shown with broken lines;

FIG. 20 is a side view of the pedal device in a fully-depressed state according to the eighth embodiment;

FIG. 21 is a side view of a pedal device according to a ninth embodiment, in which members hidden by a housing, a pedal pad, a protection plate, and the like are shown with broken lines;

FIG. 22 is a cross-sectional view taken along the line III-III in FIG. 2 in a pedal device according to a tenth embodiment, showing a pedal pad in a fully-depressed state;

FIG. 23 is a cross-sectional view taken along the line III-III in FIG. 2 in a pedal device according to an eleventh embodiment, showing a pedal pad in a fully-depressed state;

FIG. 24 is a view of a pedal device according to a twelfth embodiment when being viewed from an arrow direction XXIV in FIG. 18;

FIG. 25 is a diagram of a state in which foreign matter is caught between a housing and a protection plate when a pedal pad is depressed from a state shown in FIG. 24; and

FIG. 26 is a diagram of a state in which foreign matter is caught in a space between a floor in a vehicle compartment and the protection plate when the pedal pad is depressed from the state shown in FIG. 24.

### DETAILED DESCRIPTION

In an organ-type pedal device, a hinge portion provided at one end of a pedal pad on a lower side of a vehicle is inserted into an insertion groove provided in a support body extending from a housing toward a rear side of the vehicle, for connection thereto. This pedal device is configured, such that a diameter of an imaginary circle in contact with (e.g., tangential to) the pedal pad, the housing and the support body in a fully-depressed state is greater than a diameter of an imaginary circle in contact with the pedal pad and the housing in a non-depressed state. Here, the non-depressed state is a state in which the pedal pad is not depressed by the driver, and the fully-depressed state is a state in which the driver maximally depresses the pedal pad.

However, the organ-type pedal device described above has a configuration in which a gap is not provided at a position between the hinge portion at the end of the pedal pad on the lower side of the vehicle and the support body. Therefore, if foreign matter such as a pebble or sand that has entered a space between the housing, the support body and the pedal pad continues to accumulate without being removed, there is a concern that the accumulated foreign matter may make the pedal pad in depressible.

It is an object of the present disclosure to prevent a deterioration of a pedal pad depression operation due to entry and accumulation of foreign matter in an organ-type pedal device.

Hereinafter, a plurality of embodiments of the present disclosure will be described with reference to the drawings. In each drawing, the vertical direction of the vehicle, the longitudinal direction of the vehicle, and the lateral direction of the vehicle in which a pedal device is mounted are shown in three-dimensional coordinates. Note that an up-down direction of the vehicle is sometimes referred to as a vehicle vertical direction. In each of the following embodiments, parts that are the same or equivalent to each other are given the same reference numerals, and the description thereof will be omitted.

### First Embodiment

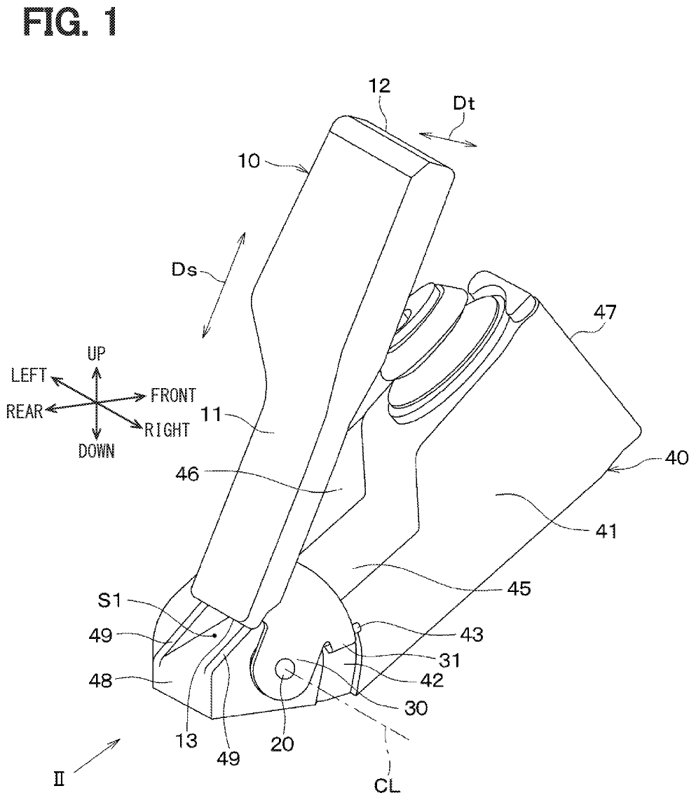

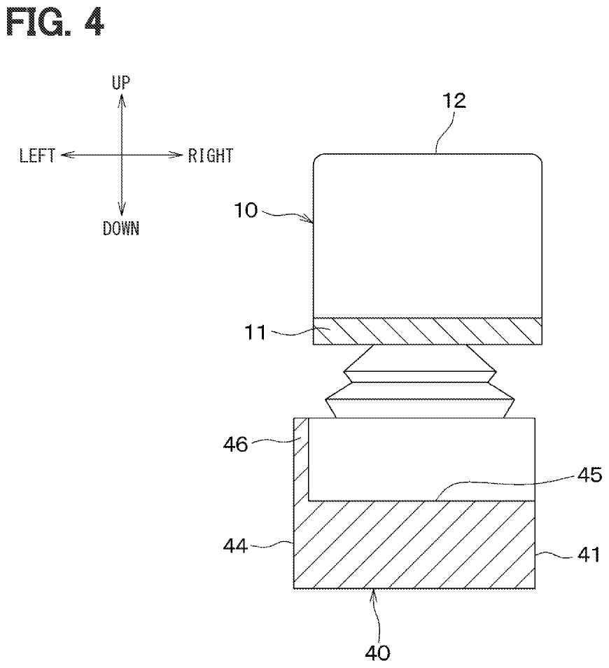

The first embodiment is described with reference to FIGS. 1 to 4. In the first embodiment, a brake pedal device will be described as an example of a pedal device mounted on a vehicle. The brake pedal device can be used, for example, in a brake-by-wire system.

As shown in FIGS. 1 to 4, the pedal device is an organ-type pedal device, and includes a pedal pad 10, a shaft member 20, a connecting portion 30, a housing 40, and the like. An organ-type pedal device is the one in which a part of the pedal pad 10 that is depressed by a driver is positioned above an axis CL of swing of the pedal pad 10 in the vertical direction when mounted on the vehicle (i.e., a part positioned upward in the vehicle than the swing axis CL). Further, in the organ-type pedal device, as a pedal force of the driver applied to the pedal pad 10 increases, a portion of the pedal pad 10 above the axis CL rotates toward a floor or a dash panel in the vehicle compartment. In the following description, an axial direction of the axis CL of swing of the pedal pad 10 will be referred to as a “pedal axis direction.” Note that when the pedal device is mounted on a vehicle, the pedal axis direction and the left-right direction of the vehicle substantially match.

The pedal pad 10 has a plate part 11 having a plate shape, having a thickness in a thickness direction Dt and extending in an extending direction Ds. When the pedal pad 10 is in a non-depressed state where the plate part 11 is not depressed by the driver, a portion on one side of the pedal pad 10 in the extending direction Ds is positioned in a lower part of the vehicle than a portion on the other side, i.e., the one side of the pedal pad 10 is positioned diagonally downward relative to the other side thereof. The pedal pad 10 swings within a predetermined angle range about the axis CL perpendicular to the extending direction Ds when the driver depresses the plate part 11 from one side in the thickness direction Dt. Note that, in the first embodiment, even when the pedal pad 10 is in a fully-depressed state where the driver's depression operation is to the full or maximized, the portion on one side of the pedal pad 10 in the extending direction Ds is lower in the vehicle than the portion on the other side. In the following description, a portion of the pedal pad 10 positioned on one side in the extending direction Ds is referred to as a pedal upper end 12, and a portion of the pedal pad 10 positioned on the other side in the extending direction Ds is referred to as a pedal lower end 13.

The shaft member 20 is a cylindrical member, and is provided at a position farther downward in the vehicle than the plate part 11 of the pedal pad 10. The shaft member 20 is provided to extend in the pedal axis direction centering on the axis CL, and is supported by the housing 40 to be rotatable about the axis CL. An end portion of the shaft member 20 in the pedal axis direction protrudes from a right side surface 41 of the housing 40. Note that the right side surface 41 of the housing 40 is a surface of the housing 40 that faces one side in the pedal axis direction (in the first embodiment, the right side of the vehicle). The connecting portion 30 connects an end of the shaft member 20 protruding from the right side surface 41 and a back surface of the pedal pad 10. Therefore, the pedal pad 10 extending from the pedal upper end 12 to the pedal lower end 13 is provided at a position above and away from the housing 40 in the vehicle.

The connecting portion 30 is a plate-shaped member, and is provided on an outside of the right side surface 41 of the housing 40. A portion of the connecting portion 30 is fixed to the end of the shaft member 20, and another portion of the connecting portion 30 on a pedal pad side is fixed to the back surface of the pedal pad 10. The connecting portion 30 moves in parallel along the right side surface 41 of the housing 40 as the pedal pad 10 swings.

A recess 42 is provided in a portion of the right side surface 41 of the housing 40. The recess 42 is provided in a portion of the right side surface 41 of the housing 40 that faces the connecting portion 30 when the pedal pad 10 swings. Further, the recess 42 is provided in a portion of the right side surface 41 of the housing 40 that is further forward of the vehicle than the shaft member 20. On the other hand, the connecting portion 30 has a restrictor 31 at a position corresponding to the recess 42 in the housing 40. The restrictor 31 is a portion where a part of the connecting portion 30 is bent and placed inside the recess 42. When the pedal pad 10 is in a non-depressed state, the restrictor 31 provided on the connecting portion 30 is locked by a locking portion 43 provided at an upper end of the recess 42 of the housing 40. This restricts move of the connecting portion 30 and the pedal pad 10 in an opposite direction that is opposite to a direction in which the pedal pad 10 moves due to an increase in the driver's pedal force when the pedal pad 10 is in a non-depressed state.

Although not shown, inside the housing 40, a bearing that rotatably supports the shaft member 20, a sensor that detects a swing angle of the pedal pad 10, a reaction force generation mechanism that generates a reaction force against the pedal force applied to the pedal pad 10 by the driver and the like are provided.

A left side surface 44 of the housing 40 is provided with a wall portion 46 extending to an upper part of the vehicle from a surface 45 of the housing 40 that faces the pedal pad 10. The wall portion 46 provided on the left side surface 44 of the housing 40 can prevent relatively large foreign matter from entering a space between the pedal pad 10 and the housing 40, from the other side in the pedal axis direction (i.e., in the first embodiment, the left side of the vehicle).

A surface 45 of the housing 40 facing the pedal pad 10 is inclined toward a lower part of the vehicle from a front side to a rear side of the vehicle when mounted on the vehicle. Therefore, even when a relatively small foreign matter such as a pebble or sand enters the space between the pedal pad 10 and the housing 40, the foreign matter will roll down toward the rear of the vehicle along the surface 45 of the housing 40 that faces the pedal pad 10.

In the first embodiment, an inclination angle between the surface 45 of the housing 40 facing the pedal pad 10 and the floor of the vehicle differs for portion to portion in the housing 40, but configuration of the inclination angle is not limited to such setting. For example, the inclination angle between the surface 45 of the housing 40 facing the pedal pad 10 and the floor of the vehicle may be the same all through the surface 45, i.e., from an end 47 of the housing 40 on a vehicle front side to an end 48 of the housing 40 on a vehicle rear side. Further, in the first embodiment, the surface 45 of the housing 40 facing the pedal pad 10 is parallel to the pedal axis direction, but configuration of the surface 45 is not limited thereto. For example, as described in the second embodiment, and the like, a portion of the surface 45 of the housing 40 facing the pedal pad 10 may be inclined with respect to the pedal axis direction.

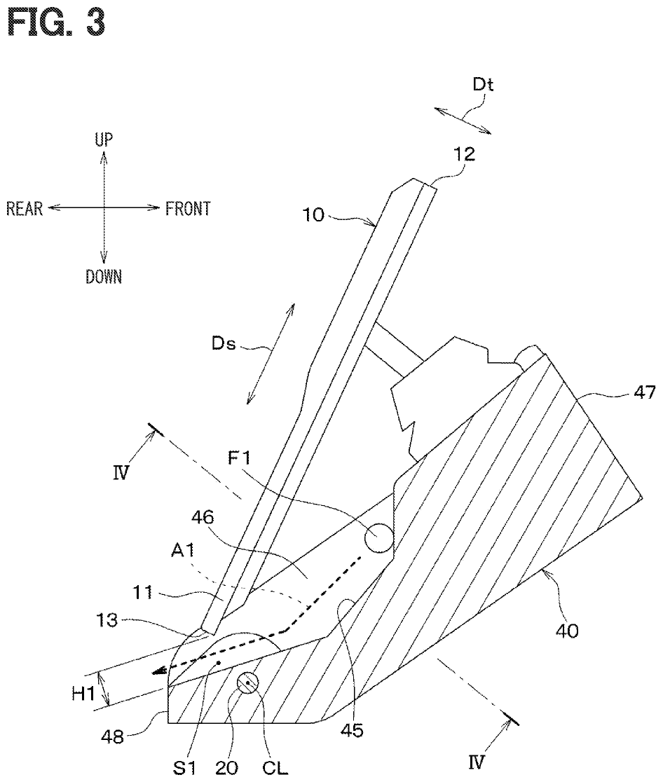

As described above, in the pedal device of the first embodiment, the shaft member 20 is provided at a position farther downward from the pedal pad 10 in the vehicle, and the end of the shaft member 20 and the back surface of the pedal pad 10 are connected by the connecting portion 30. Therefore, the pedal device has a gap S1 at a position between the housing 40 and the pedal lower end 13, which is an end portion of the pedal pad 10 on the lower side of the vehicle. The gap S1 between the pedal lower end 13 and the housing 40 and a space between the pedal pad 10 and the housing 40 are continuous in the vehicle longitudinal direction. Further, a distance H1 in the vehicle vertical direction of the gap S1 between the pedal lower end 13 and the housing 40 is set to a height that allows relatively small foreign matter such as pebbles and sand to be removed. In FIG. 3, when a relatively small foreign matter F1 such as a pebble or sand enters the space between the pedal pad 10 and the housing 40, the behavior of the foreign matter F1 is shown by a broken line arrow A1. As indicated by the broken line arrow A1, the foreign matter F1 rolls down toward the rear of the vehicle along the surface 45 of the housing 40 facing the pedal pad 10, and is removed to an outside of the pedal device from the gap S1 between the pedal lower end 13 and the housing 40.

Note that, in a part of the surface 45 of the housing 40 facing the pedal pad 10, protrusions 49 that protrude upward in the vehicle are provided on the left and right sides in the pedal axis direction at a portion corresponding to the shaft member 20, respectively. A gap S2 is also provided at a position between the protrusion 49 and the pedal pad 10. The gap S2 between the protrusion 49 and the pedal pad 10 and the shape of the protrusion 49 will be explained later in detail in the seventh embodiment. Note that it is also possible to configure the housing 40 without providing the protrusion 49.

The pedal device of the first embodiment described above is configured to have the gap S1 at a position between the pedal lower end 13 and the housing 40. According to the above, when foreign matter enters in a space between the housing 40 and the pedal pad 10, the foreign matter rolls down toward the rear of the vehicle along the surface 45 of the housing 40 facing the pedal pad 10. Then, the foreign matter is removed by gravity from the gap S1 between the pedal lower end 13 and the housing 40. Therefore, in this pedal device, since foreign matter does not accumulate in the space between the housing 40 and the pedal pad 10, a problem of the pedal pad 10, which may make the pedal pad 10 to be not depressible due to foreign matter, is prevented. Therefore, deterioration of the depression operation of the pedal pad 10 due to the intrusion and accumulation of foreign matter is prevented in the present pedal device. Such a pedal device, as a brake pedal device, can further enhance the safety of braking of the vehicle.

### Second Embodiment

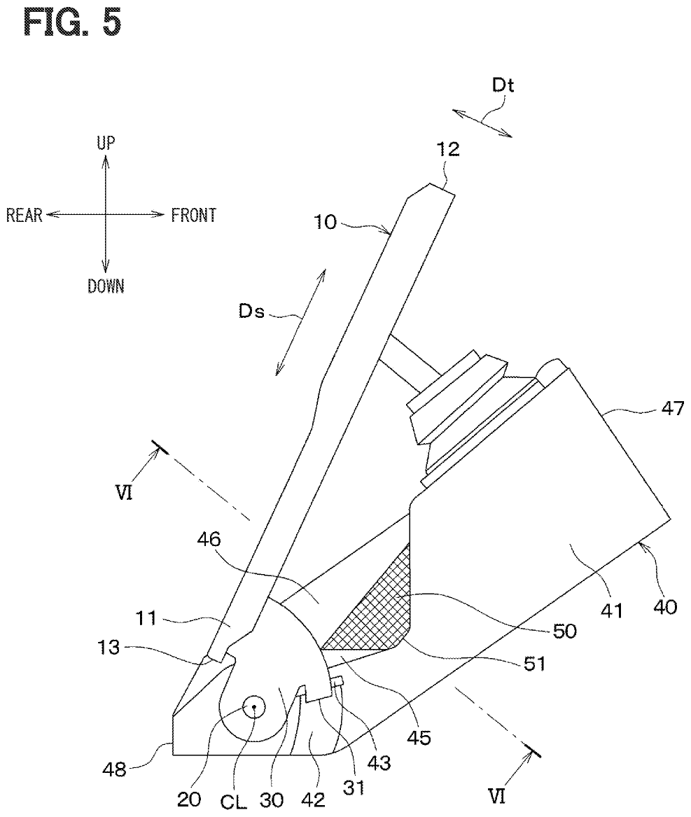

The second embodiment will be described with reference to FIGS. 5 to 7. In the second embodiment, a part of the shape of a housing 40 is changed from the first embodiment, and the rest is the same as the first embodiment, so the different parts from the first embodiment will be mainly explained.

As shown in FIGS. 5 to 7, the housing 40 of the pedal device according to the second embodiment has, as a part of the surface 45 facing the pedal pad 10, a left-right inclined surface 50 which is inclined toward a lower part of the vehicle along a left-right direction relative to the pedal axis (i.e., the left-right direction of the vehicle).

In FIG. 5, in order to clearly show the left-right inclined surface 50, the surface 50 is cross-hatched although not a cross section.

The left-right inclined surface 50 of the second embodiment is inclined toward a lower part of the vehicle from a left side surface 44 side toward a right side surface 41 side. The wall portion 46 extending from the left side surface 44 toward the upper part of the vehicle is provided on the left side surface 44 to which a portion of the left-right inclined surface 50 on an upper side of the vehicle is connected. On the other hand, a connection position 51 between a portion of the left-right inclined surface 50 on the lower side of the vehicle and the right side surface 41 is positioned at a position shifted toward the front of the vehicle relative to the connecting portion 30 and the restrictor 31.

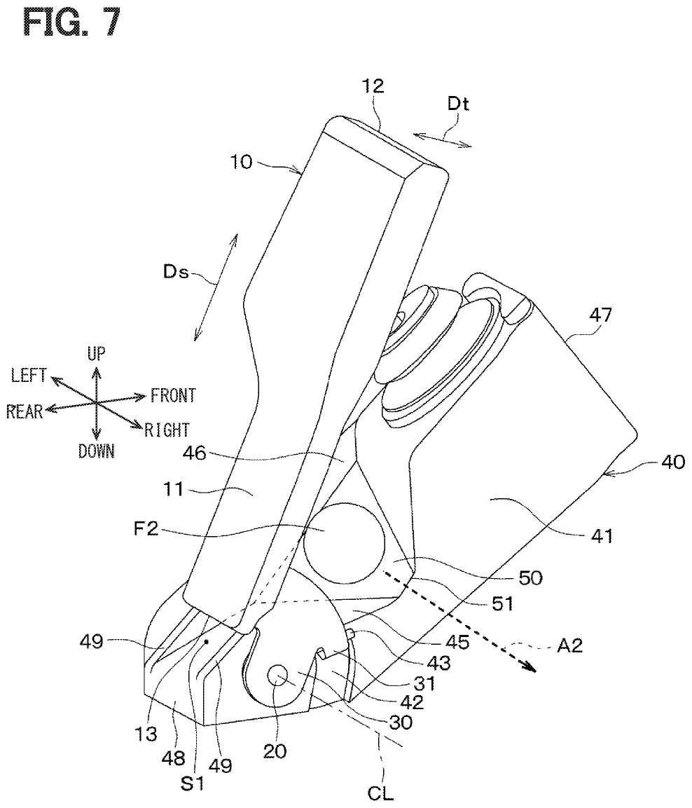

As shown in FIG. 7, in the second embodiment, when a relatively large foreign matter F2 is caught in a space between the housing 40 and the pedal pad 10, when the driver depresses the pedal pad 10, a pedal force is applied from the pedal pad 10 to the foreign matter F2. Then, as shown by a broken line arrow A2 in FIG. 7, the foreign matter F2 moves toward the lower part of the vehicle along the left-right inclined surface 50, and is pushed out to the right of the housing 40 from the connection position 51 between a portion of the left-right inclined surface 50 on the lower side of the vehicle and the right side surface 41.

In the second embodiment described above, the connection position 51 between a portion of the left-right inclined surface 50 on the lower part of the vehicle and the right side surface 41 is put at a position shifted toward the front of the vehicle relative to the connecting portion 30 and the restrictor 31. Therefore, when a foreign matter caught in a space between the housing 40 and the pedal pad 10 receives a pedal force from the pedal pad 10, the foreign matter moves toward the lower part of the vehicle along the left-right inclined surface 50, and is pushed out to the right of the housing 40 without interfering with the regulating part 31 and the connecting portion 30. In such manner, even when a relatively large foreign matter is caught in a space between the housing 40 and the pedal pad 10, the pedal device described above is capable of removing the foreign matter by the depression operation of the pedal pad 10. Therefore, in such pedal device, foreign matter removability from a space between the housing 40 and the pedal pad 10 is improved, and a problem of the pedal pad 10, which may make the pedal pad 10 to be in a non-depressed state due to foreign matter, is prevented.

### Third to Fifth Embodiments

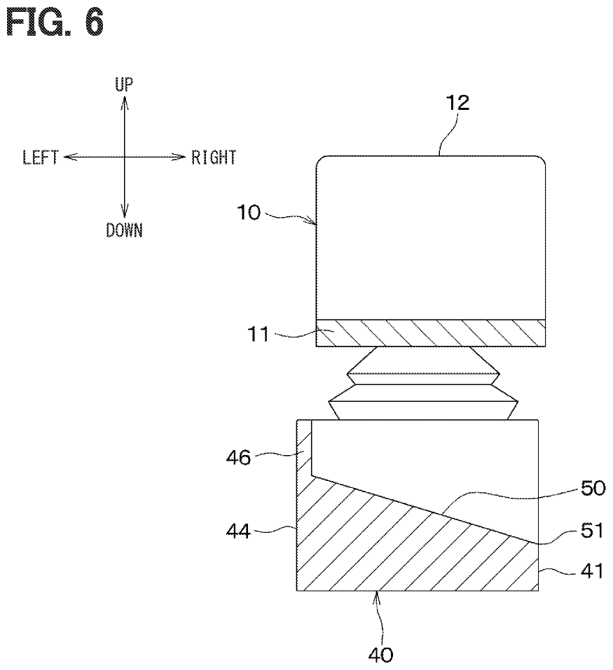

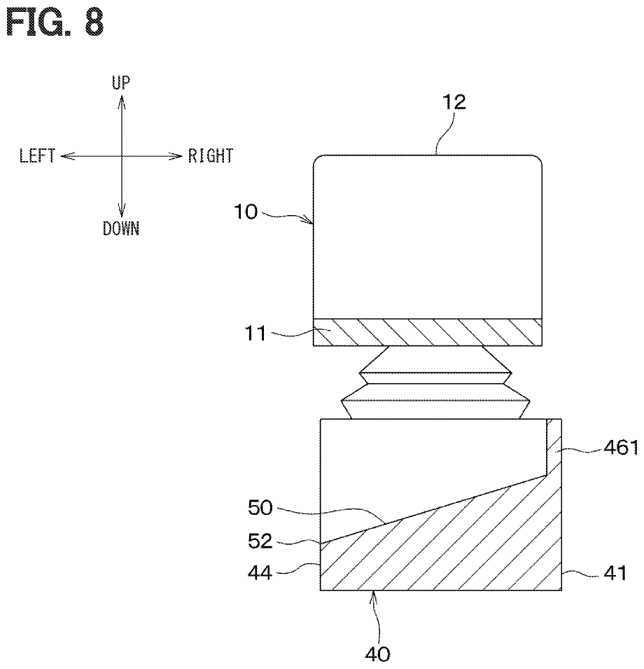

The third to fifth embodiments differ from the second embodiment in that the configurations of the left-right inclined surface 50 and the wall portion 46 are changed, and other aspects are the same as the second embodiment. Only the different parts will be mainly explained. Note that FIGS. 8 to 10 referred to in the third to fifth embodiments are cross-sectional views of the portion corresponding to FIG. 6 referred to in the second embodiment.

### Third Embodiment

As shown in FIG. 8, in the third embodiment, a left-right inclined surface 50 provided on a part of the surface 45 of the housing 40 facing the pedal pad 10 is inclined toward the lower part of the vehicle from the right side surface 41 to the left side surface 44. A wall portion 461 extending from the right side surface 41 toward the upper part of the vehicle is provided on the right side surface 41 to which a portion of the left-right inclined surface 50 on an upper side of the vehicle is connected.

Although not shown, in the third embodiment, the connecting portion 30 that connects the end of the shaft member 20 and the back surface of the pedal pad 10 is provided on a left side surface 44 side of the housing 40. In such case, a connection position 52 between a portion of the left-right inclined surface 50 on the lower side of the vehicle and the left side surface 44 is put at a position shifted toward the front side of the vehicle relative to the connecting portion 30 and the restrictor 31.

In the third embodiment as well, in a situation in which a relatively large foreign matter is caught in a space between the housing 40 and the pedal pad 10, when the driver depresses the pedal pad 10, the pedal pad 10 applies the pedal force to the foreign matter. When the foreign matter receives the pedal force from the pedal pad 10, the foreign matter moves toward the lower part of the vehicle along the left-right inclined surface 50, and is pushed out to the left of the housing 40 without interfering with the restrictor 31 and the connecting portion 30. Therefore, the pedal device has an improved removability of foreign matter from the space between the housing 40 and the pedal pad 10, thereby preventing a problem such as the pedal pad 10 becoming inoperable due to accumulation of foreign matter. In the following description, among the wall portions 46 and 461, the wall portion 46 extending from the left side surface 44 toward an upper part of the vehicle may be referred to as a “left wall portion 46,” and the wall portion 461 extending from the right side surface 41 toward the upper part of the vehicle may be referred to as a “right wall portion 461.”

### Fourth Embodiment

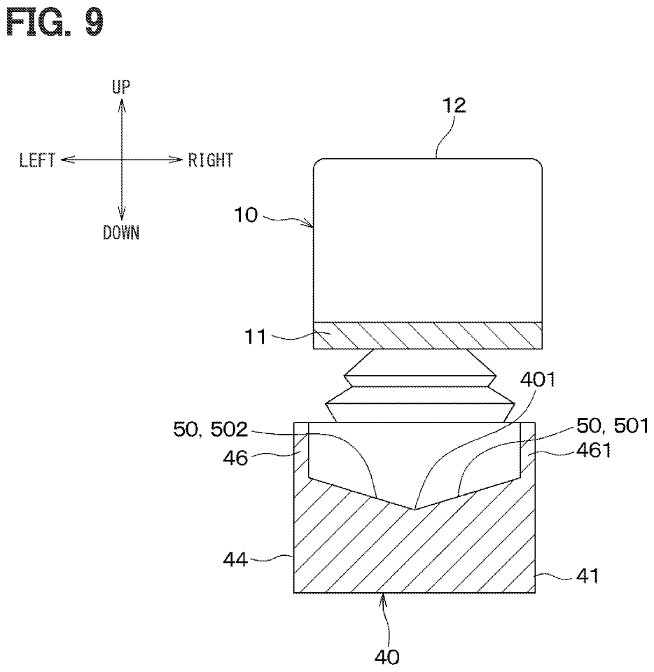

As shown in FIG. 9, in the fourth embodiment, a housing 40 has a right wall portion 461 extending from the right side surface 41 toward the upper part of the vehicle, and a left wall portion 46 extending from the left side surface 44 toward an upper part of the vehicle. In such case, a left-right inclined surface 50 include a first inclined surface 501 that is inclined downward toward the lower part of the vehicle from the right side surface 41 to a center portion 401 of the housing 40, and a second inclined surface 502 that is inclined downward toward the lower part of the vehicle from the left side surface 44 to the center portion 401 of the housing 40. Note that the center portion 401 of the housing 40 refers to the center portion 401 of the housing 40 in the pedal axis direction. In such manner, the left-right inclined surface 50 of the fourth embodiment have a shape that is inclined downward toward the lower part of the vehicle while being included from the left side surface 44 and from the right side surface 41 toward the center portion 401.

In the fourth embodiment, since the housing 40 has the right wall portion 461 and the left wall portion 46, relatively large foreign matter is prevented from entering the space between the housing 40 and the pedal pad 10. On the other hand, the relatively small foreign matter such as pebbles, sand and the like that have entered the space between the housing 40 and the pedal pad 10 is collected at the center portion 401 of the housing 40 by the first inclined surface 501 and the second inclined surface 502. Then, as described in the first embodiment, the foreign matter rolls toward the rear of the vehicle along the surface 45 of the housing 40 facing the pedal pad 10, and the foreign matter rolls toward the rear of the vehicle, and is removed to an outside of the vehicle from the gap S1 between the lower end 13 of the pedal and the housing 40. Therefore, the pedal device of the fourth embodiment can also prevent a problem in which the pedal pad 10 becomes inoperable due to accumulation of foreign matter.

### Fifth Embodiment

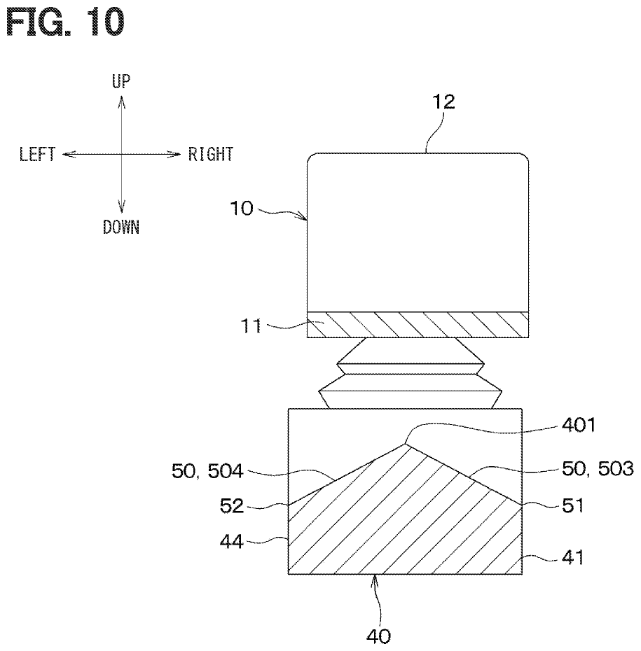

As shown in FIG. 10, in the fifth embodiment, neither a right side surface 41 nor a left side surface 44 of a housing 40 is provided with a wall portion. In such case, a left-right inclined surface 50 includes a third inclined surface 503 that is inclined downward toward the lower part of the vehicle from the center portion 401 of the housing 40 to the right side surface 41 of the vehicle, and a fourth inclined surface 504 that is inclined downward toward the lower part of the vehicle from the center portion 401 of the housing 40 to the left side surface 44. In such manner, the left-right inclined surface 50 of the fifth embodiment has a shape that is inclined downward toward the lower part of the vehicle from the center portion 401 to the right side surface 41 and to the left side surface 44.

Although not shown, in the fifth embodiment as well, the connecting portion 30 that connects the end of the shaft member 20 and the back surface of the pedal pad 10 is provided on the left side surface 44 of the housing 40. In such case, the connection position 51 between (a) a portion of the third inclined surface 503 on the lower side of the vehicle and (b) the right side surface 41 is shifted toward the front of the vehicle than the connecting portion 30 and the restrictor 31.

In the fifth embodiment, when a relatively large foreign matter is caught in the space between the housing 40 and the pedal pad 10, when the driver depresses the pedal pad 10, the pedal force is applied from the pedal pad 10 to the foreign matter.

When the foreign matter receives the pedal force from the pedal pad 10, the foreign matter moves along the third inclined surface 503 or the fourth inclined surface 504 toward the right side surface 41 or the left side surface 44, and is pushed out to the right or left of the housing 40 without interfering with the restrictor 31 and/or the connecting portion 30. Therefore, the pedal device has an improved removability of foreign matter from the space between the housing 40 and the pedal pad 10, thereby preventing a problem such as the pedal pad 10 becoming inoperable due to accumulation of foreign matter.

### Sixth Embodiment

Next, the sixth embodiment will be described, but before describing the sixth embodiment, a configuration of a pedal device of a reference example and its problems will be described. Note that the pedal device of the reference example was created as an example by the inventors of the present disclosure and is not a prior art.

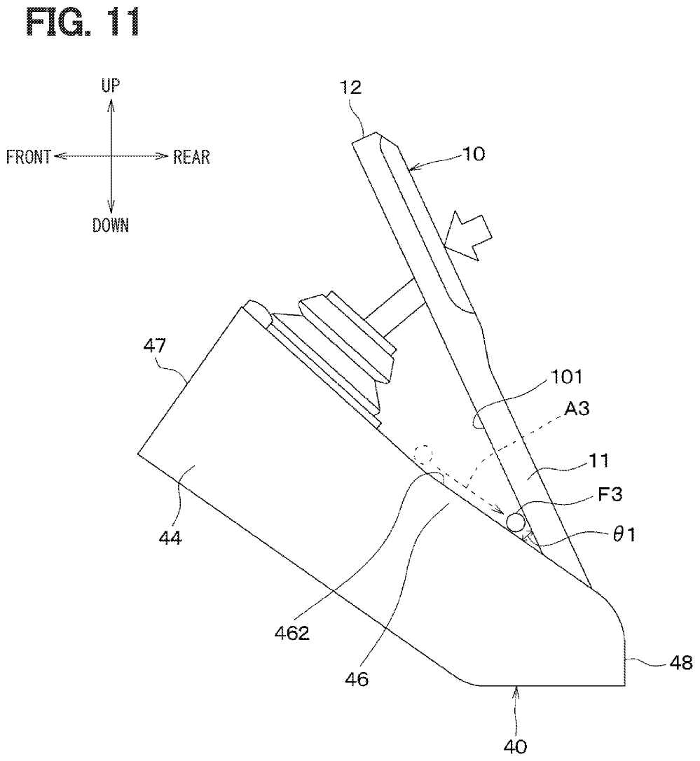

As shown in FIG. 11, the pedal device of the reference example has a wall portion 46 on a left side surface 44 of a housing 40 as shown in FIG. 11. Although not shown, a connecting portion 30 connecting a pedal pad 10 and a shaft member 20 is provided on a right side surface 41 side of the housing 40. In the pedal device of this reference example, an angle θ1 between (a) a surface 462 of the wall portion 46 of the housing 40 facing an upper part of the vehicle and (b) a surface 101 of the pedal pad 10 facing the housing 40 is an acute angle when seen from the pedal axis direction.

In the configuration of such reference example, as shown by an arrow A3, when a long and thin foreign matter F3 such as a twig enters a space between the wall portion 46 of the housing 40 and the pedal pad 10 and moves downward due to gravity, the foreign matter F3 is bound the housing 40 and the pedal pad 10. Then, there is a problem that the foreign matter F3 becomes an obstacle and the pedal pad 10 cannot be depressed.

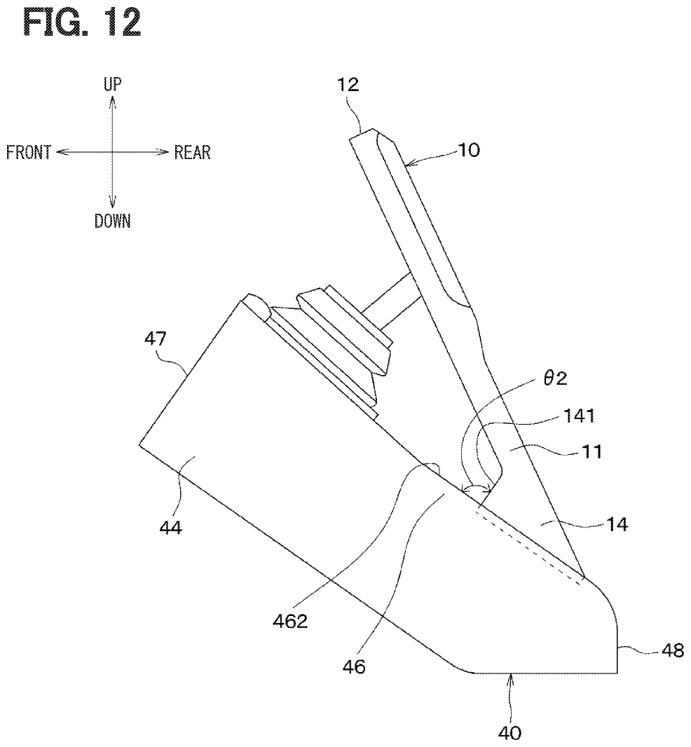

In view of the above, the pedal device of the sixth embodiment solves such problems of the pedal device of the reference example described above. As shown in FIG. 12, a pedal pad 10 included in a pedal device of the sixth embodiment has a pad lower wall portion 14 extending from a plate part 11 toward the housing 40. The pad lower wall portion 14 is provided at a position (a) adjacent to the wall portion 46 of the housing 40 in the pedal axis direction and (b) facing the connecting portion 30 in the pedal axis direction. With such configuration, in the sixth embodiment, an angle θ2 between (a) a surface 141 of the pad lower wall portion 14 facing the front of the vehicle and (b) the surface 462 of the wall portion 46 of the housing 40 facing an upper part of the vehicle is greater than that of the pedal of the reference example. This angle is greater than the angle θ1 shown in FIG. 11 in the description of the pedal device of the reference example.

The angle θ2 formed by the surface 141 of the pad lower wall portion 14 facing the front of the vehicle and the surface 462 of the wall portion 46 of the housing 40 facing an upper part of the vehicle is preferably set to, for example, 45 degrees or more when seen from the pedal axis direction. In such manner, even when a foreign matter enters the space between the surface 141 of the pad lower wall portion 14 facing the front of the vehicle and the surface 462 of the wall portion 46 of the housing 40 facing an upper part of the vehicle, a certain pedaling margin is guaranteed for the pedal pad 10. Note that the angle θ2 formed by the surface 141 of the pad lower wall portion 14 facing toward the front of the vehicle and the surface 462 of the wall portion 46 of the housing 40 facing an upper part of the vehicle is not limited to 45 degrees. For example, the angle θ2 may preferably be set to 60 degrees or more, and more preferably 90 degrees or more, from a viewpoint of guaranteeing a certain pedaling margin on the pedal pad 10 against foreign matter.

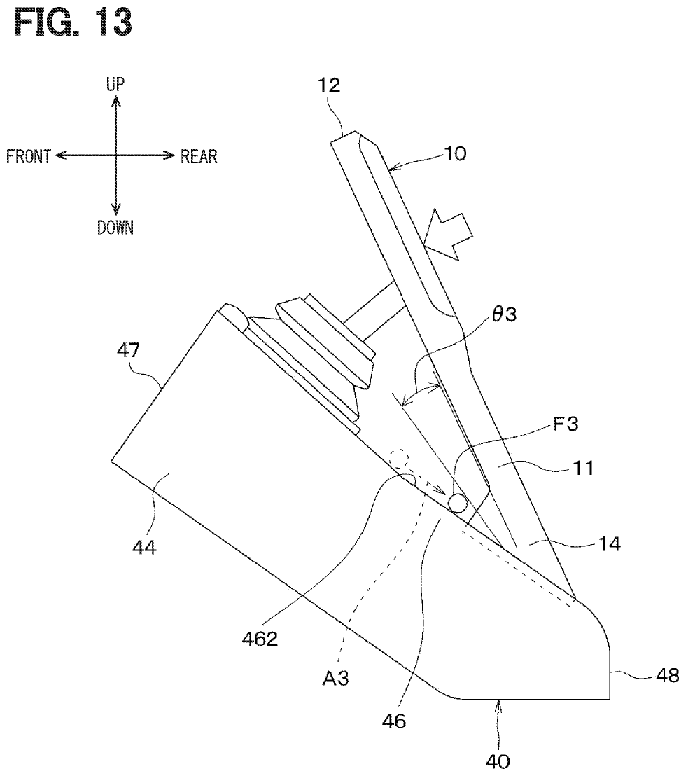

As shown in FIG. 13, in the configuration of the sixth embodiment, even when the long and thin foreign matter F3, such as a twig, enters the space between the wall portion 46 of the housing 40 and the pedal pad 10, and, as shown by the arrow A3, moves downward due to gravity, a certain pedaling margin angle θ3 is guaranteed for the pedal pad 10. Therefore, the driver can depress the pedal pad 10 to decelerate the vehicle. Therefore, such pedal device can suppress deterioration of the depression operation of the pedal pad 10 due to foreign matter that has entered the space between the wall portion 46 of the housing 40 and the pedal pad 10.

### Seventh Embodiment

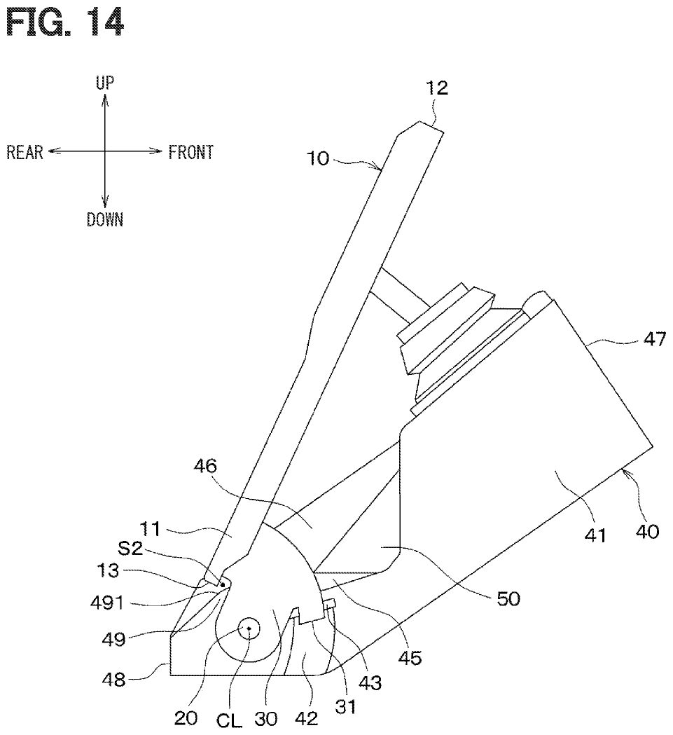

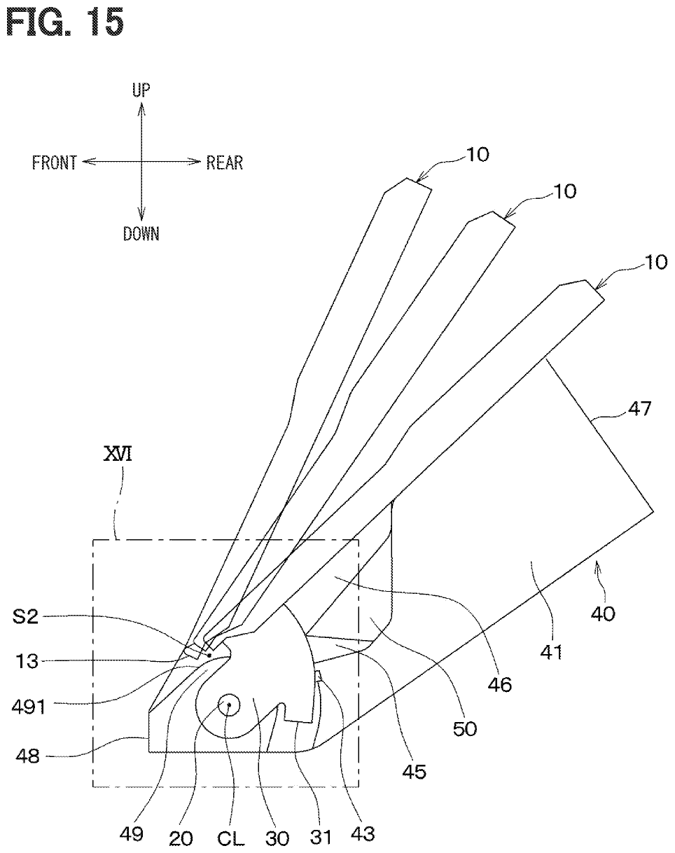

The seventh embodiment will be described with reference to FIGS. 14 to 16. In the seventh embodiment, the shapes of protrusions 49 provided on the left and right sides in the pedal axis direction on a part of a surface 45 of a housing 40 facing a pedal pad 10 and a gap S2 between the protrusions 49 and the pedal pad 10 will be explained.

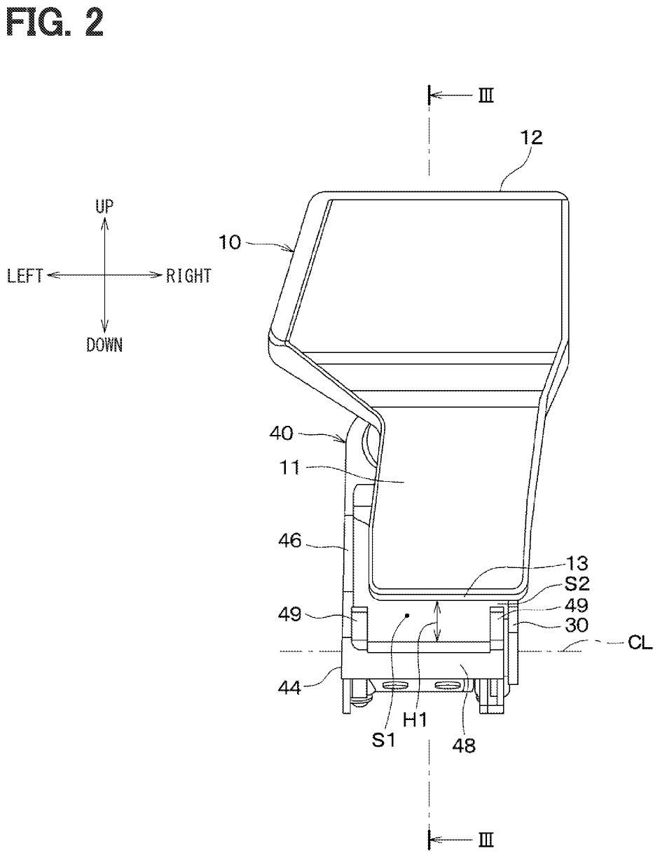

As shown in FIGS. 1 and 2 in the description of the first embodiment, in a part of the surface 45 of the housing 40 facing the pedal pad 10, the left and right sides of the pedal axis direction in the portion corresponding to the shaft member 20 are each provided with a protrusion 49 that protrudes toward an upper part of the vehicle.

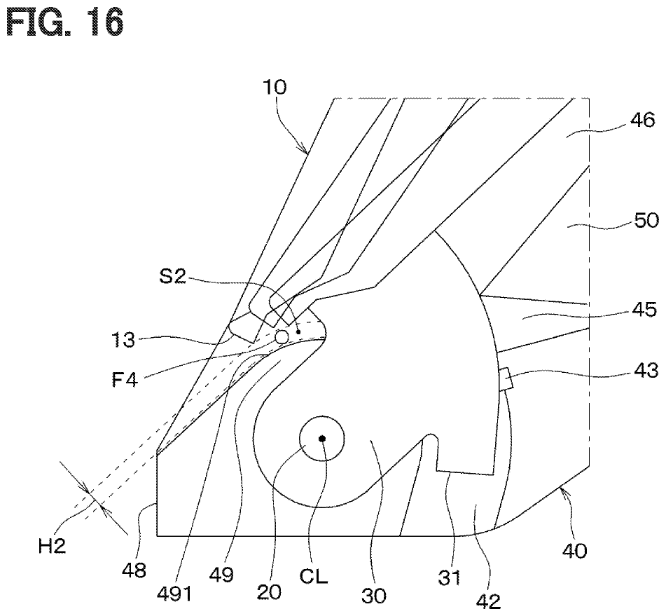

As shown in FIGS. 14 to 16, a surface 491 of the protrusion 49 that faces the lower end 13 of the pedal swinging from the fully-depressed state to the non-depressed state is an arc-shaped curved surface centered on the axis CL. Therefore, as shown by an arrow H2 in FIG. 16, the gap S2 between the protrusion 49 and the pedal lower end 13 maintains a constant size throughout the swinging from the fully-depressed state to the non-depressed state of the pedal pad 10.

Compared to the distance H1 in the vehicle vertical direction of the gap S1 between the pedal lower end 13 and the housing 40 shown in FIGS. 2 and 3 in the description of the first embodiment, the gap S2 between the pedal lower end 13 and the housing 40 shown in FIG. 16 is smaller. Therefore, it is conceivable that a foreign matter F4 remains in the gap S2 between the pedal lower end 13 and the housing 40 without being removed. In view of such a situation, the seventh embodiment has a configuration in which the gap S2 between the pedal lower end 13 and the housing 40 is maintained at a constant size throughout the swinging of the pedal from the fully-depressed state to the non-depressed state of the pedal pad 10. Therefore, even when the foreign matter F4 remains in the gap S2 between the lower end 13 of the pedal and the housing 40, the pedal pad 10 does not become in a non-depressed state during the depression operation or will not stop while returning from a depressed state. Therefore, the pedal device of the seventh embodiment guarantees an appropriate operation of the pedal pad 10 for both of the depression operation and the return from the depression operation, even when foreign matter enters the gap S2 between the protrusion 49 and the lower end 13 of the pedal.

### Eighth Embodiment

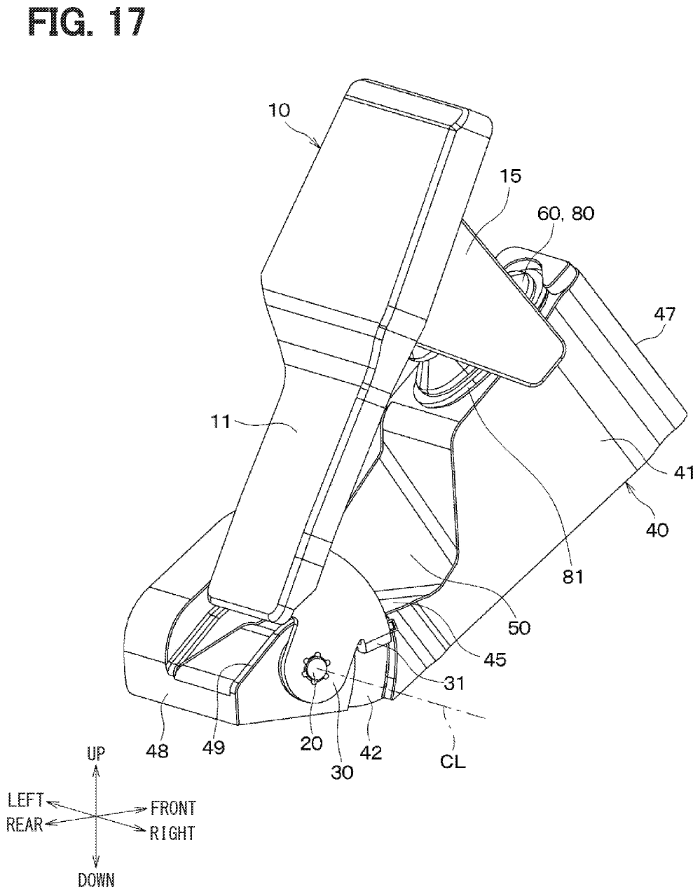

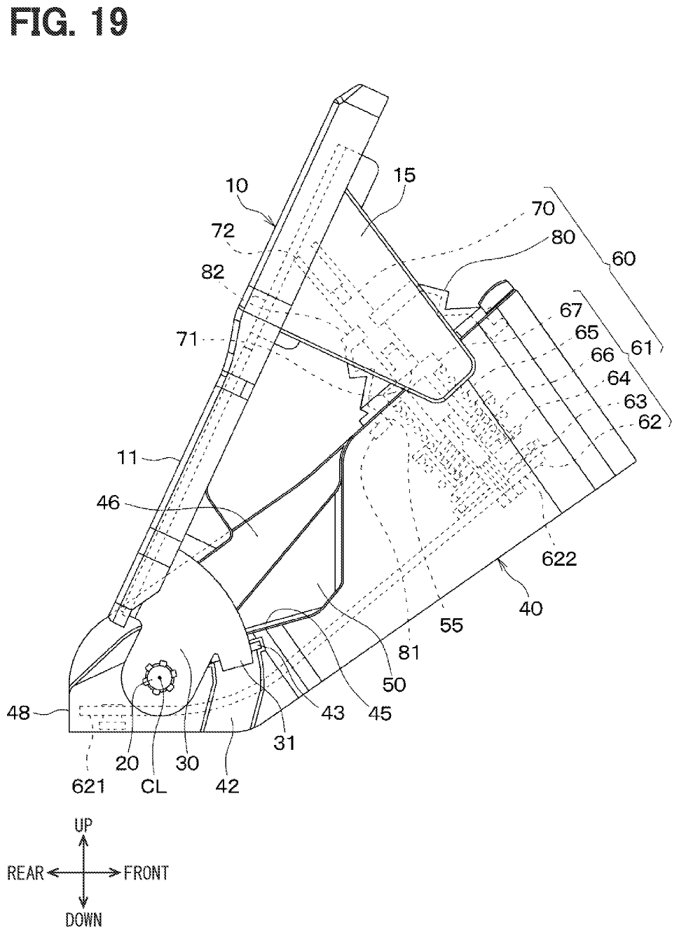

The eighth embodiment will be described with reference to FIGS. 17 to 20. A pedal device of the eighth embodiment includes a protection plate 15 extending from a pedal pad 10 toward a housing 40. The protection plate 15 protects a portion of a connecting structure 60 that protrudes to an outside of the housing 40. As shown in FIG. 19, the connecting structure 60 is a member that protrudes from inside the housing 40 to the outside of the housing 40 and is connected to the pedal pad 10, and includes a reaction force generation mechanism 61, a connecting rod 70, a cover member 80.

First, the reaction force generation mechanism 61, the connecting rod 70, and the cover member 80 that constitute the connecting structure 60 will be described. The reaction force generation mechanism 61 generates a reaction force against a pedal force applied to the pedal pad 10 by a depression operation of the driver. The reaction force generation mechanism 61 includes a leaf spring 62, a lower holder 63, a large diameter coil spring 64, a small diameter coil spring 65, a spring seat 66, and an upper holder 67.

One longitudinal end 621 of the leaf spring 62 is fixed to the housing 40, and an other longitudinal end 622 of the leaf spring 62 is a free end. The leaf spring 62 is elastically deformable in a direction intersecting the axial direction of the swing axis CL of the pedal pad 10 (hereinafter referred to as “pedal axis direction”). The lower holder 63 is fixed to the other end 622 of the leaf spring 62 in the longitudinal direction.

The large diameter coil spring 64 is held by the lower holder 63. The spring seat 66 is provided at a position between the large diameter coil spring 64 and the small diameter coil spring 65. The spring seat 66 connects the large diameter coil spring 64 and the small diameter coil spring 65. The upper holder 67 is provided on a pedal pad 10 side of the small diameter coil spring 65. In such manner, by configuring the reaction force generation mechanism 61 to include a plurality of elastic members (i.e., the leaf spring 62, the large diameter coil spring 64, and the small diameter coil spring 65), it is possible to form any pedal force characteristics.

One end 71 of the connecting rod 70 is slidable relative to the upper holder 67, and an other end 72 is fixed to a lower surface of the pedal pad 10. The connecting rod 70 is capable of transmitting the pedal force applied to the pedal pad 10 by the driver to the reaction force generation mechanism 61, and transmitting the reaction force generated by the reaction force generation mechanism 61 to the pedal pad 10. Further, the connecting rod 70 defines a position of the pedal pad 10 in a non-depressed state where the driver is not depressing the pedal pad 10.

The cover member 80 is made of, for example, a rubber material, and has a bellows-like cylindrical shape. One end 81 of the cover member 80 fits to a peripheral edge of a housing hole 55 in the housing 40. Further, an other end 82 of the cover member 80 is fitted in a middle of the connecting rod 70. The cover member 80 covers part of the reaction force generation mechanism 61 and the connecting rod 70, and prevents foreign matter from entering the inside of the housing 40 from the housing hole 55.

By the way, if the driver unintentionally kicks the above-mentioned connecting structure 60 (that is, the cover member 80, the connecting rod 70, and the reaction force generation mechanism 61), for example, the cover member 80 may be torn, or the connecting rod 70 may be bent, which is a problem. To address such a problem, the pedal device of the eighth embodiment includes a protection plate 15 that protects a portion of the connecting structure 60 that protrudes to the outside of the housing 40.

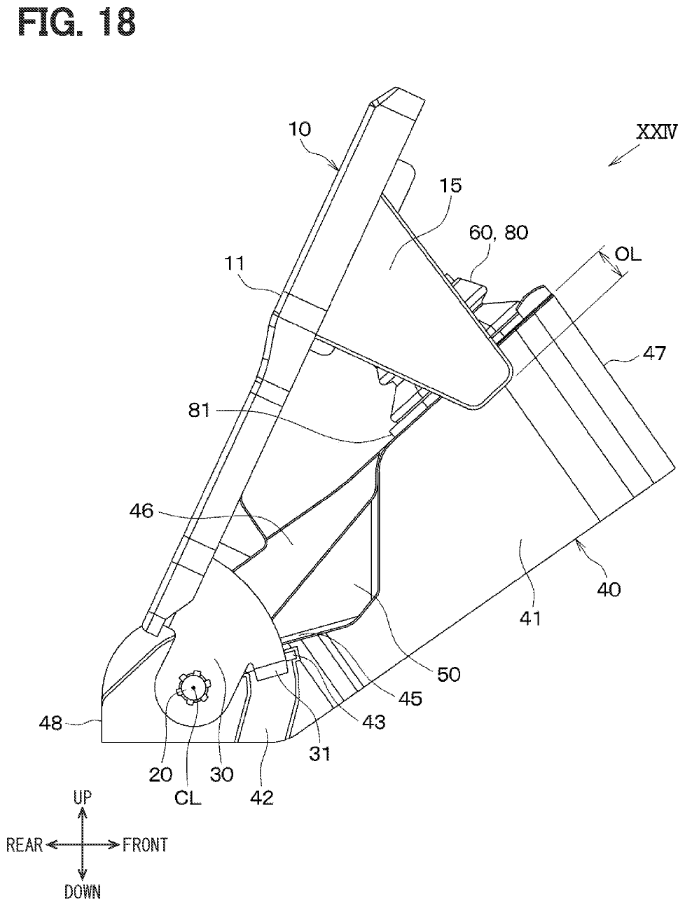

The protection plate 15 extends from the pedal pad 10 toward the housing 40 and is provided at a position overlapping with at least a portion of the connecting structure 60 described above in the pedal axis direction. Further, as shown by an arrow OL in FIG. 18, a portion of the protection plate 15 and a portion of a side surface of the housing 40 overlap in the pedal axis direction even in the non-depressed state. In such manner, even when a force is applied to the protection plate 15 from outside the pedal device, such as when the protection plate 15 is kicked by the driver's foot, a load applied to the protection plate 15 can be received by the housing 40. Therefore, the protection plate 15 can reliably protect the connecting structure 60.

Note that the protection plate 15 may be provided on both of right and left sides of the pedal pad 10, or may be provided only on the right side of the pedal pad 10, or may be provided only on the left side of the pedal pad 10. In other words, the protection plate 15 may be provided on both sides in the pedal axis direction with respect to the connecting structure 60, or only on one side or the other side in the pedal axis direction with respect to the connecting structure 60.

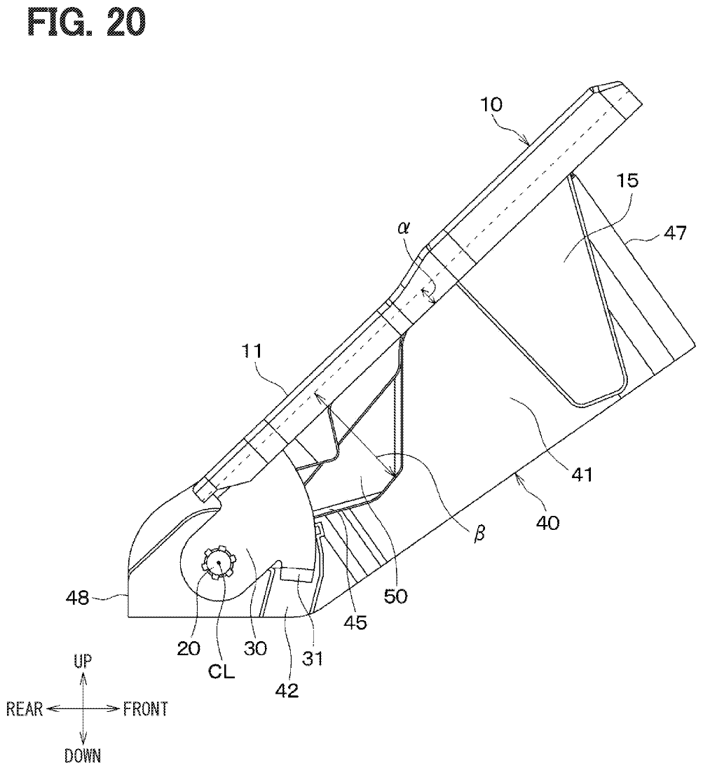

Here, FIG. 20 shows a fully-depressed state in which the pedal pad 10 rotates to the full due to the driver's depression operation. As shown in FIG. 20, in the fully-depressed state, a space between the pedal pad 10 and the housing 40 has areas where the distance between the pedal pad 10 and the housing 40 is short and long in a direction perpendicular to the pedal pad 10. Specifically, the area where the distance between the pedal pad 10 and the housing 40 is short is an area including a position indicated by an arrow α in FIG. 20. The area where the distance between the pedal pad 10 and the housing 40 is long is an area including a position indicated by an arrow β in FIG. 20. Note that the area where the distance between the pedal pad 10 and the housing 40 is long corresponds to an area where the left-right inclined surface 50 is formed on a part of the surface 45 of the housing 40 facing the pedal pad 10.

The protection plate 15 does not cover the area where the distance between the pedal pad 10 and the housing 40 is long in the space between the pedal pad 10 and the housing 40. Therefore, such an area with long distance is open to one side or the other side in the pedal axis direction. Therefore, the left-right inclined surface 50 of the housing 40 is not covered with the protection plate 15, and is open on one side in the pedal axis direction where the protection plate 15 is disposed. In such manner, even when foreign matter is caught between the housing 40 and the pedal pad 10, when the driver depresses the pedal pad 10, the foreign matter will move along the left-right inclined surface 50 without interfering with the protection plate 15 to the outside of the housing 40.

The pedal device of the eighth embodiment described above includes the protection plate 15 on the lower surface of the pedal pad 10. The protection plate 15 is provided at a position overlapping with at least a portion of the connecting structure 60 in the pedal axis direction. The protection plate 15 does not cover the area where the distance between the pedal pad 10 and the housing 40 is long in the fully-depressed state. Therefore, the area with the long distance is not covered by the protection plate 15 and is open to at least one side or the other side in the pedal axis direction where the protection plate 15 is disposed.

According to the above, the pedal device of the eighth embodiment protects the connecting structure 60 with the protection plate 15, and is capable of removing the foreign matter that have entered the space between the housing 40 and the pedal pad 10 from the area where the distance between the pedal pad 10 and the housing 40 is long. Therefore, such pedal device can achieve both of the protection of the connecting structure 60 and the removability of foreign matter without compromise.

Further, in the eighth embodiment, as shown by the arrow OL in FIG. 18, in the non-depressed state, a portion of the protection plate 15 and a portion of the side surface of the housing 40 overlap in the pedal axis direction. According to the above, even when the protection plate 15 is kicked in the pedal axis direction by the driver's foot or the like in the non-depressed state, the load applied to the protection plate 15 is receivable by such structure. Therefore, the connecting structure 60 is reliably protected by the protection plate 15.

Note that the protection plate may be formed of metal, resin, or the like, or may be formed of an elastic member such as rubber.

### Ninth Embodiment

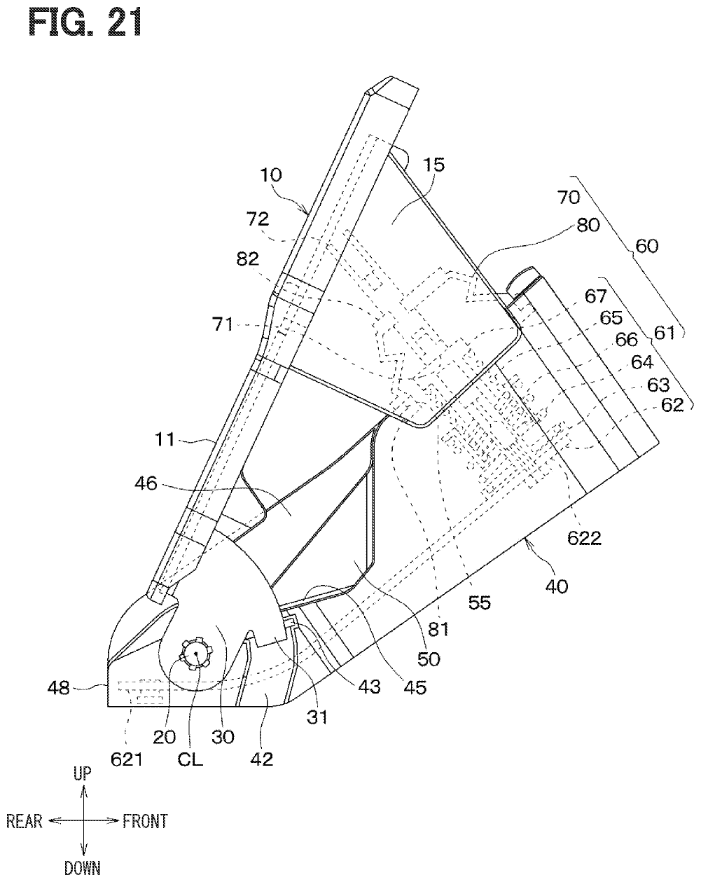

The ninth embodiment will be described with reference to FIG. 21. A protection plate 15 included in the pedal device of the ninth embodiment has a wider width in the vehicle longitudinal direction (i.e., vehicle front-rear direction) than that described in the eighth embodiment. The protection plate 15 is provided at a position overlapping with an entirety of the connecting structure 60 protruding from the housing 40 in the pedal axis direction. Thereby, the protection plate 15 can reliably protect the portion where the connecting structure 60 protrudes from the housing 40.

In the ninth embodiment as well, the protection plate 15 does not cover the area where the distance between the pedal pad 10 and the housing 40 is long in the space between the pedal pad 10 and the housing 40. Therefore, the area with the long distance is open to at least one side or the other side in the pedal axis direction where the protection plate 15 is disposed. Therefore, even when foreign matter is caught in the space between the housing 40 and the pedal pad 10, when the driver depresses the pedal pad 10, the foreign matter moves along the left-right inclined surface 50 without interfering with the protection plate 15, and is pushed out of the housing 40.

The pedal device of the ninth embodiment described above achieves the same effects as those of the eighth embodiment.

### Tenth Embodiment

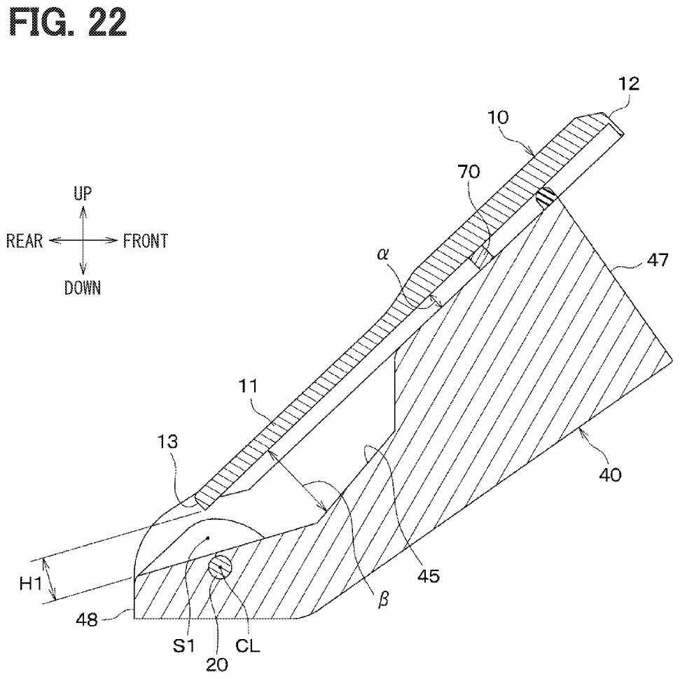

The tenth embodiment will be described with reference to FIG. 22. In the tenth embodiment, a gap S1 between a pedal lower end 13 and a housing 40 described in the first embodiment will be explained in more details.

FIG. 22 is a cross-sectional view taken along the line III-III in FIG. 2 in a state where the pedal pad 10 is depressed to the full (hereinafter referred to as “fully-depressed state”). In addition, in FIG. 22, the structure inside the housing 40 is omitted.

As shown in FIG. 22, in the fully-depressed state, the space between the pedal pad 10 and the housing 40 has an area where the distance between the pedal pad 10 and the housing 40 is short and an area where the distance between the pedal pad 10 and the housing 40 is long in the direction perpendicular to the pedal pad 10. Specifically, the area where the distance between the pedal pad 10 and the housing 40 is short is an area including the position indicated by the distance α in FIG. 22. The large area where the distance between the pedal pad 10 and the housing 40 is long is an area including the position indicated by the distance β in FIG. 22.

In the tenth embodiment, a distance H1 of the gap S1 between the pedal lower end 13 and the housing 40 is greater than a distance α of the area where the distance between the pedal pad 10 and the housing 40 is short in the fully-depressed state. Note that the distance H1 of the gap S1 between the pedal lower end 13 and the housing 40 refers to the distance H1 between the pedal lower end 13 and the housing 40 in the gap S1 between the pedal lower end 13 and the housing 40. The distance α in the area where the distance between the pedal pad 10 and the housing 40 is short refers to the distance α between the pedal pad 10 and the housing 40 in an area where distance between the pedal pad 10 and the housing 40 is short. Further, the space between the pedal pad 10 and the housing 40 and the gap S1 between the pedal lower end 13 and the housing 40 are continuous in the vehicle longitudinal direction.

By the way, although not shown in the drawings, if the distance H1 of the gap S1 between the pedal lower end 13 and the housing 40 is smaller than the distance α of the area where the pedal pad 10 and the housing 40 is short, the following problem will occur. That is, in other words, if a foreign matter of a size equivalent to the distance α between the pedal pad 10 and the housing 40 has entered the space between the pedal pad 10 and the housing 40, the foreign matter of that size will not be removed from the gap S1 between the pedal lower end 13 and the housing 40. Therefore, the foreign matter ends up as accumulation at the space between the pedal pad 10 and the housing 40. Therefore, a concern arises that the depression operation of the pedal pad 10 may deteriorate.

In view of the above, the pedal device of the tenth embodiment is configured in that, the distance H1 of the gap S1 between the pedal lower end 13 and the housing 40 is greater than the distance α of the area where the pedal pad 10 and the housing 40 is short in the fully-depressed state. Therefore, it is possible to remove the foreign matter having a size equal to or smaller than the distance α between the pedal pad 10 and the housing 40 from the gap S1 between the pedal lower end 13 and the housing 40. Thus, such pedal device can suppress the accumulation of foreign matter in the space between the pedal pad 10 and the housing 40, and thereby preventing deterioration of the depression operation of the pedal pad 10.

### Eleventh Embodiment

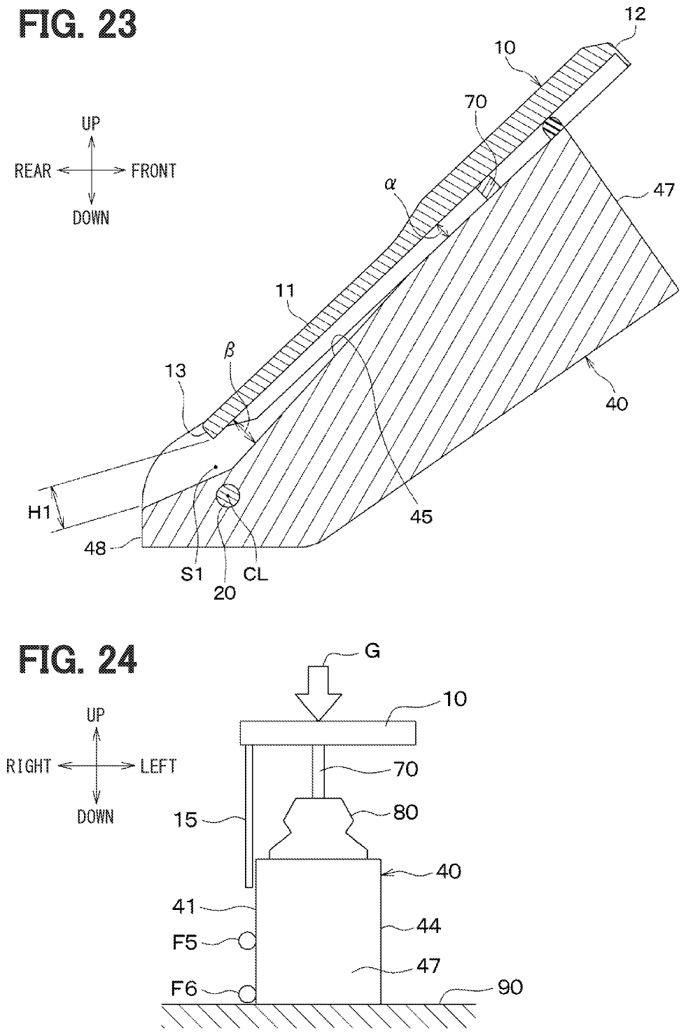

The eleventh embodiment will be described with reference to FIG. 23. The eleventh embodiment is a modification of the tenth embodiment.

As shown in FIG. 23, in the eleventh embodiment as well, in the fully-depressed state, a space between a pedal pad 10 and a housing 40 has an area where a distance between the pedal pad 10 and the housing 40 in the direction perpendicular to the pedal pad 10 is long, and an area where a distance therebetween is short. However, in the eleventh embodiment, a distance β between the pedal pad 10 and the housing 40 in the area where the distance between the pedal pad 10 and the housing 40 is long is smaller than a distance H1 of a gap S1 between a pedal lower end 13 and the housing 40.

Also in the eleventh embodiment, the distance H1 of the gap S1 between the pedal lower end 13 and the housing 40 is greater than the distance α in the area where the distance between the pedal pad 10 and the housing 40 is short in the fully-depressed state. Therefore, the pedal device of the eleventh embodiment can also achieve the same effects as the pedal device of the tenth embodiment.

### Twelfth Embodiment

The twelfth embodiment will be described with reference to FIGS. 24 to 26. In the twelfth embodiment, the structure of the protection plate 15 described in the eighth embodiment and the ninth embodiment will be described in more details.

In the twelfth embodiment, a protection plate 15 is formed of an elastic member that is elastically deformable by a pedal force G applied to a pedal pad 10 by the driver's depression operation. Specifically, the protection plate 15 is made of an elastic member such as rubber or elastomer.

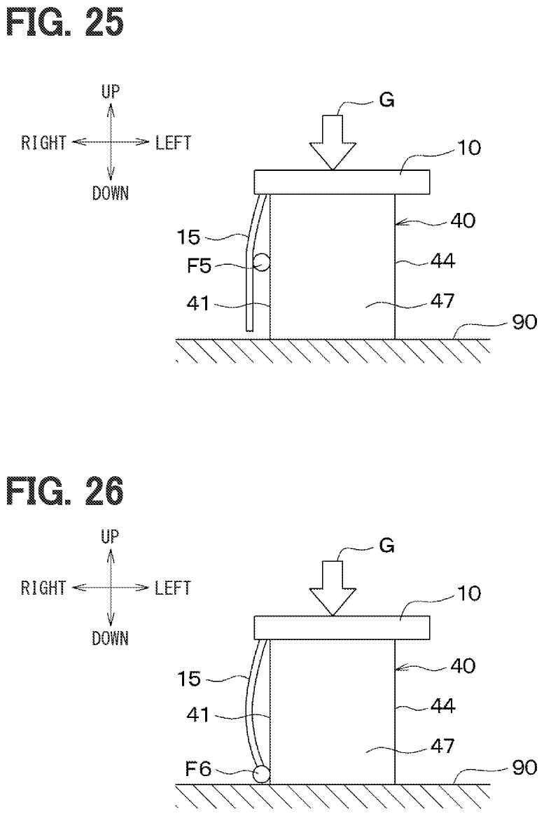

FIG. 24 is a view taken in a direction of an arrow XXIV in FIG. 18, that is, a view of the pedal device viewed from the front side of the vehicle. FIG. 24 shows a non-depressed state in which the driver does not perform a depression operation on the pedal pad. On the other hand, FIGS. 25 and 26 show a fully-depressed state in which the driver's depression operation on the pedal pad is conducted to the full.

FIG. 25 illustrates a state in which a foreign matter F5 is caught between a side surface 41 of the housing 40 and the protection plate 15. In such case, the protection plate 15 is elastically deformed by the pedal force G applied to the pedal pad 10 by the driver's depression operation. Therefore, the driver can perform the depression operation of the pedal pad 10.

Further, FIG. 26 illustrates a state in which a foreign matter F6 is caught between a floor 90 of the vehicle and the protection plate 15. Also in such case, the protection plate 15 is elastically deformed by the pedal force G applied to the pedal pad 10 by the driver's depression operation. Therefore, the driver can perform the depression operation of the pedal pad 10.

As explained above, in the pedal device of the twelfth embodiment, by forming the protection plate 15 with an elastic member, the safety of vehicle braking can be further improved as a brake pedal device.

### Other Embodiments

(1) In each of the above-described embodiments, a brake pedal device has been described as an example of a pedal device, but the pedal device is not limited thereto, and the pedal device may be an accelerator pedal device.
(2) In each of the above-described embodiments, the brake pedal device is described as being used in a brake-by-wire system, but the brake pedal device is not limited to such, and can be used, for example, in a brake system in which a master cylinder and a brake pedal device are mechanically connected.
(3) In each of the above-described embodiments, the shaft member 20 is described as a cylindrical member, and the connecting portion 30 is described as a plate-like member. However, the shaft member 20 and the connecting member 30 may be integrally formed by bending a column-shape member or otherwise, for example.
(4) In each of the embodiments described above, the restrictor 31 is provided in a part of the connecting portion 30, but the restrictor 31 is not limited thereto, and may be provided in a member that moves together with the pedal pad 10.
(5) In each of the above-described embodiments, the protrusions 49 are provided on the left and right sides in the pedal axis direction on a part of the surface 45 of the housing 40 facing the pedal pad 10, but the present disclosure is not limited thereto. That is, the protrusions 49 may be eliminated. Alternatively, the protrusions 49 may be provided on an outside of the right side surface 41 and on an outside of the left side surface 44 of the housing 40.
(7) In the eighth and ninth embodiments, a portion of the protection plate 15 and a portion of the side surface of the housing 40 overlap in the pedal axis direction in the non-depressed state, but the present disclosure is not limited thereto. For example, by increasing the thickness of the protection plate 15 to raise its rigidity, the protection plate 15 and a part of the side surface of the housing 40 may be configured not to overlap in the pedal axis direction.
(8) In FIGS. 17 to 21 referred to in the eighth and ninth embodiments described above, in the space between the pedal pad 10 and the housing 40, the area where the distance between the pedal pad 10 and the housing 40 is long is illustrated as a configuration in which the area is open on one side in the pedal axis direction. However, the configuration is not limited thereto. For example, the first to third, fifth to seventh embodiments and the eighth and ninth embodiments may be combined, and the area where the distance between the pedal pad 10 and the housing 40 is long may be configured to be open to the other side in the pedal axis direction, or alternatively, such an area may be open on both of the one side and the other side in the pedal axis direction.

The present disclosure is not limited to the above-described embodiments, and can be appropriately modified. The above-described embodiments are not independent of each other, and can be appropriately combined together except when the combination is obviously impossible. Further, individual elements or features of a particular embodiment are not necessarily essential unless it is specifically stated that the elements or the features are essential in the foregoing description, or unless the elements or the features are obviously essential in principle. Further, in each of the embodiments described above, when numerical values such as the number, numerical value, quantity, range, and the like of the constituent elements of the embodiment are referred to, except in case where the numerical values are expressly indispensable in particular, or in case where the numerical values are obviously limited to a specific number in principle, and the like, the present disclosure is not limited to such specific number. Further, in each of the embodiments described above, when referring to the shape, positional relationship, and the like of the elements and the like, it is not limited to a specific shape, positional relationship, and the like, except for a case where the elements are explicitly specified, or for a case where the components are fundamentally limited to a specific shape, positional relationship, and the like.

The features of the present disclosure are described in the following.

### [First Aspect]

A pedal device includes: a pedal pad including a plate-shaped plate part that has a thickness in a thickness direction and extends in an extending direction, and configured to be rotatable about an axis perpendicular to the extending direction when a driver performs a depression operation on the plate part from one side in the thickness direction; a shaft member extending in an axial direction of the axis at a position separated and downward from the plate part in a vehicle; a housing rotatably supporting the shaft member; and a connecting portion configured to connect the pedal pad and the shaft member. The pedal device is an organ-type pedal device in which a pedal upper end on one side in the extending direction of the pedal pad is positioned at an upper position of the vehicle than a pedal lower end on an another side in the extending direction of the pedal pad, in a non-depressed state in which the depression operation by the driver is not performed on the plate part, and a gap is provided between the housing and the pedal lower end.

According to the above, if foreign matter that has entered a space between the housing and the pedal pad moves toward a rear side of the vehicle along a surface of the housing that faces the pedal pad, it is possible to remove the foreign matter from the gap between the pedal lower end and the housing. Therefore, in this pedal device, foreign matter does not accumulate in a space between the housing and the pedal pad, thereby preventing a problem in which the pedal pad is not depressible due to foreign matter. Thus, deterioration of the depression operation of the pedal pad due to an intrusion and accumulation of the foreign matter can be prevented.

### [Second Aspect]

In the pedal device according to the first aspect, the pedal pad extending from the pedal upper end to the pedal lower end is provided at a position away from the housing, and a space between the pedal pad and the housing and the gap between the housing and the pedal lower end are continuous in a longitudinal direction of the vehicle.

### [Third Aspect]

In the pedal device according to the first aspect or the second aspect, the housing includes a left-right inclined surface provided as a part of a surface facing the pedal pad and inclined toward a lower side of the vehicle along the axis direction, a right side surface facing on one side in the axis direction, and a left side surface facing on the other side in the axis direction, and a connection position, between (i) the right side surface or the left side surface on which the connecting portion is provided and (ii) a portion of the left-right inclined surface on a lower side of the vehicle, is a position shifted from the connecting portion toward a front of the vehicle.

### [Fourth Aspect]

In the pedal device according to the third aspect, a restrictor is provided on the right side surface or the left side surface on which the connecting portion is provided, and is configured to restrict, in the non-depressed state, a moving of the connecting portion and the pedal pad in an opposite direction opposite to a moving direction of the pedal pad moved in accordance with an increase of a pedal force of the driver. In addition, the connection position between (i) the right side surface or the left side surface on which the connecting portion is provided and (ii) the portion of the left-right inclined surface on the lower side of the vehicle is the position shifted from the connecting portion toward the front of the vehicle.

### [Fifth Aspect]

In the pedal device according to any one of the first aspect to the fourth aspect, the housing includes:
a right side surface facing one side in the axial direction of the axis;
a left side surface facing an another side in the axial direction of the axis; and
a wall portion extending toward an upper side of the vehicle from at least one of the right side surface or the left side surface.

### [Sixth Aspect]

In the pedal device according to any one of the first aspect to the fifth aspect, the housing includes:
a left-right inclined surface provided as a part of a surface facing the pedal pad and inclined toward a lower side of the vehicle along the axis direction of the axis;
a right side surface facing one side in the axial direction of the axis;
a left side surface facing an another side in the axial direction of the axis; and
a wall portion extending toward an upper side of the vehicle from an upper portion of the left-right inclined surface.

### [Seventh Aspect]

In the pedal device according to the fifth aspect or the sixth aspect, the pedal pad includes a pad lower wall portion extending from the plate part toward the housing at a position (i) adjacent to the wall portion of the housing in the axial direction of the axis and (ii) facing the connecting portion in the axial direction of the axis.

### [Eighth Aspect]

In the pedal device according to the seventh aspect, an angle formed by (i) a surface of the pad lower wall portion facing the front of the vehicle and (ii) a surface of the wall portion of the housing facing an upper side of the vehicle is set to be equal to or greater than 45 degrees when being viewed from the axial direction of the axis.

### [Ninth Aspect]

In the pedal device according to any one of the first aspect to the eighth aspect, a protrusion protruding toward an upper side of the vehicle is provided in a part of the surface of the housing facing the pedal pad in a portion corresponding to the shaft member, and a gap between the protrusion of the housing and the pedal lower end maintains a constant size throughout rotation of the pedal pad due to the depression operation by the driver from (i) a fully-depressed state in which the pedal pad rotates fully to (ii) the non-depressed state.

### [Tenth Aspect]

In the pedal device according to the ninth aspect, a surface of the protrusion of the housing facing the pedal lower end during swinging from the fully-depressed state to the non-depressed state is an arc-shaped curved surface centered on the axis.

### [Eleventh Aspect]

The pedal device according to any one of the first aspect to the tenth aspect, further includes: a connecting structure protruding from an interior of the housing to an exterior of the housing, and connected to the pedal pad; and a protection plate extending from the pedal pad toward the housing, and provided at a position which is overlapped with at least a part of a protruding position of the connecting structure protruding to the exterior of the housing in an axial direction of the axis. In the pedal device, a space, between the pedal pad and the housing in a fully-depressed state of the pedal pad in which the pedal pad is fully rotated due to the depression operation of the driver, includes (i) a short-distance area where a distance between the pedal pad and the housing is short and (ii) a long-distance area where a distance between the pedal pad and the housing is long as compared with the short-distance area. In addition, the protection plate is configured without covering the long-distance area, and the long-distance area is open to at least one of one side or other side in the axial direction of the axis, on which the protection plate is provided.

### [Twelfth Aspect]

In the pedal device according to the eleventh aspect, the connecting structure includes: a reaction force generation mechanism generating a reaction force against a pedal force applied to the pedal pad by the depression operation of the driver; a connecting rod connecting the reaction force generation mechanism and the pedal pad; and a cover member covering a part of the connecting rod.

### [Thirteenth Aspect]

In the pedal device according to the eleventh aspect or the twelfth aspect, in the non-depressed state, a part of a side surface of the housing and a part of the protection plate overlap in the axial direction of the axis.

### [Fourteenth Aspect]

In the pedal device according to any one of the first aspect to the thirteenth aspect, a distance of the gap between the pedal lower end and the housing is greater than a distance between the pedal pad and the housing in an area where the pedal pad and the housing is shortest in the fully-depressed state in which the pedal pad rotates fully due to the depression operation by the driver.

### [Fifteenth Aspect]

In the pedal device according to any one of the first aspect to the fourteenth aspect, a space, between the pedal pad and the housing in a fully-depressed state of the pedal pad due to the depression operation of the driver in which the pedal pad is rotated fully, includes (i) a short-distance area where a distance between the pedal pad and the housing is short and (ii) a long-distance area where a distance between the pedal pad and the housing is long as compared with the short-distance area. In addition, a distance of a gap between the pedal lower end and the housing is greater than a distance between the pedal pad and the housing in the short-distance area where the distance between the pedal pad and the housing is short in the fully-depressed state.

### [Sixteenth Aspect]

The pedal device according to any one of the first aspect to the fifteenth aspect further includes: a connecting structure protruding from an interior of the housing to an exterior of the housing, and connected to the pedal pad; and a protection plate extending from the pedal pad toward the housing and overlapping at least a part of a protruding portion of the connecting structure protruding to the exterior of the housing in the axis direction. In the pedal device, the protection plate is made of an elastic member that is elastically deformable by a pedal force applied to the pedal pad by the driver.

What is claimed is:

1. A pedal device comprising:
a pedal pad including a plate-shaped plate part that has a thickness in a thickness direction and extends in an extending direction, and configured to be rotatable about an axis perpendicular to the extending direction when a driver performs a depression operation on the plate part from one side in the thickness direction;
a shaft member extending in an axial direction of the axis at a position separated and downward from the plate part in a vehicle;
a housing rotatably supporting the shaft member; and
a connecting portion configured to connect the pedal pad and the shaft member, wherein
the pedal device is an organ-type pedal device in which a pedal upper end on one side in the extending direction of the pedal pad is positioned at an upper position of the vehicle than a pedal lower end on an another side in the extending direction of the pedal pad, in a non-depressed state in which the depression operation by the driver is not performed on the plate part, and
a gap is provided between the housing and the pedal lower end.

2. The pedal device according to claim 1, wherein
the pedal pad extending from the pedal upper end to the pedal lower end is provided at a position away from the housing, and
a space between the pedal pad and the housing and the gap between the housing and the pedal lower end are continuous in a longitudinal direction of the vehicle.

3. The pedal device according to claim 1, wherein
the housing includes: a left-right inclined surface provided as a part of a surface facing the pedal pad and inclined toward a lower side of the vehicle along the axis direction; a right side surface facing on one side in the axis direction; and a left side surface facing on the other side in the axis direction, and
a connection position, between (i) the right side surface or the left side surface on which the connecting portion is provided and (ii) a portion of the left-right inclined surface on a lower side of the vehicle, is a position shifted from the connecting portion toward a front of the vehicle.

4. The pedal device according to claim 3, wherein
a restrictor is provided on the right side surface or the left side surface on which the connecting portion is provided, and is configured to restrict, in the non-depressed state, a moving of the connecting portion and the pedal pad in an opposite direction opposite to a moving direction of the pedal pad moved in accordance with an increase of a pedal force of the driver, and
the connection position between (i) the right side surface or the left side surface on which the connecting portion is provided and (ii) the portion of the left-right inclined surface on the lower side of the vehicle is the position shifted from the connecting portion toward the front of the vehicle.

5. The pedal device according to claim 1, wherein
the housing includes:
a right side surface facing one side in the axial direction of the axis;
a left side surface facing an another side in the axial direction of the axis; and
a wall portion extending toward an upper side of the vehicle from at least one of the right side surface or the left side surface.

6. The pedal device according to claim 1, wherein
the housing includes:
a left-right inclined surface provided as a part of a surface facing the pedal pad and inclined toward a lower side of the vehicle along the axis direction of the axis;
a right side surface facing one side in the axial direction of the axis;
a left side surface facing an another side in the axial direction of the axis; and
a wall portion extending toward an upper side of the vehicle from an upper portion of the left-right inclined surface.

7. The pedal device according to claim 5, wherein
the pedal pad includes
a pad lower wall portion extending from the plate part toward the housing at a position (i) adjacent to the wall portion of the housing in the axial direction of the axis and (ii) facing the connecting portion in the axial direction of the axis.

8. The pedal device according to claim 7, wherein
an angle formed by (i) a surface of the pad lower wall portion facing the front of the vehicle and (ii) a surface of the wall portion of the housing facing an upper side of the vehicle is equal to or greater than 45 degrees when being viewed from the axial direction of the axis.

9. The pedal device according to claim 1, wherein
a protrusion protruding toward an upper side of the vehicle is provided in a part of the surface of the housing facing the pedal pad in a portion corresponding to the shaft member, and
a gap between the protrusion of the housing and the pedal lower end maintains a constant size throughout rotation of the pedal pad due to the depression operation by the driver from (i) a fully-depressed state in which the pedal pad rotates fully to (ii) the non-depressed state.

10. The pedal device according to claim 9, wherein
a surface of the protrusion of the housing facing the pedal lower end during swinging from the fully-depressed state to the non-depressed state is an arc-shaped curved surface centered on the axis.

11. The pedal device according to claim 1, further comprising:
a connecting structure protruding from an interior of the housing to an exterior of the housing, and connected to the pedal pad; and
a protection plate extending from the pedal pad toward the housing, and provided at a position which is overlapped with at least a part of a protruding position of the connecting structure protruding to the exterior of the housing in an axial direction of the axis, wherein
a space, between the pedal pad and the housing in a fully-depressed state of the pedal pad in which the pedal pad is fully rotated due to the depression operation of the driver, includes (i) a short-distance area where a distance between the pedal pad and the housing is short and (ii) a long-distance area where a distance between the pedal pad and the housing is long as compared with the short-distance area,
the protection plate is configured without covering the long-distance area, and
the long-distance area is open to at least one of one side or other side in the axial direction of the axis, on which the protection plate is provided.

12. The pedal device according to claim 11, wherein the connecting structure includes:
a reaction force generation mechanism generating a reaction force against a pedal force applied to the pedal pad by the depression operation of the driver;
a connecting rod connecting the reaction force generation mechanism and the pedal pad; and
a cover member covering a part of the connecting rod.

13. The pedal device according to claim 11, wherein
in the non-depressed state, a part of the side surface of the housing and a part of the protection plate overlap in the axial direction of the axis.

14. The pedal device according to claim 1, wherein
a distance of the gap between the pedal lower end and the housing is greater than a distance between the pedal pad and the housing in an area where the pedal pad and the housing is shortest in the fully-depressed state in which the pedal pad rotates to fully due to the depression operation by the driver.

15. The pedal device according to claim 1, wherein
a space, between the pedal pad and the housing in a fully-depressed state of the pedal pad due to the depression operation of the driver in which the pedal pad is rotated fully, includes (i) a short-distance area where a distance between the pedal pad and the housing is short and (ii) a long-distance area where a distance between the pedal pad and the housing is long as compared with the short-distance area, and
a distance of a gap between the pedal lower end and the housing is greater than a distance between the pedal pad and the housing in the short-distance area where the distance between the pedal pad and the housing is short in the fully-depressed state.

16. The pedal device according to claim 1, further comprising:
a connecting structure protruding from an interior of the housing to an exterior of the housing, and connected to the pedal pad; and
a protection plate extending from the pedal pad toward the housing and overlapping at least a part of a protruding portion of the connecting structure protruding to the exterior of the housing in the axis direction, wherein
the protection plate is made of an elastic member that is elastically deformable by a pedal force applied to the pedal pad by the driver.
